(19) United States
(12) Patent Application Publication
(10) Pub. No.: US 2006/0277080 A1
(43) Pub. Date: Dec. 7, 2006

(54) Method and system for automatically testing information technology control

(76) Inventors: Patrick DeMartine, Loveland, CO (US); Amy Lynette DeMartine, Fort Collins, CO (US); Carrie Jean Gilstrap, Palo Alto, CA (US); Damian Horner, Belfast (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/144,364

(22) Filed: Jun. 3, 2005

(51) Int. Cl. G06F 17/50

(52) U.S. Cl. 705/7

(57) ABSTRACT

A method and system for automatically testing information technology control. The method includes automatically accessing a plurality of data results pertinent to a plurality of process-based leading indicators and a plurality of symptomatic lagging indicators, wherein the plurality of process-based leading indicators is correlated with the plurality of symptomatic lagging indicators. In addition, the method includes automatically aggregating at least a portion of the plurality of data results into at least one process control indicator for providing an overview picture of the IT control and the emerging risk for at least one process control area.

### BACKGROUND

The outsourcing of Information Technology (IT) services is a common practice in today's business environment. As such, a company that is managing its customer's outsourced IT functions is managing risk on behalf of its customer. Customers expect visibility as to how the managing company is managing the processes that they, the customer, have chosen to outsource. Currently, the most common and widely accepted form of evaluating how processes are managed is that of performing an on-site audit examination. However, audit examinations are static, time consuming and expensive.

In addition, the passing into law of the Sarbanes-Oxley Act of 2002 requires annual attestation of control activities by an external auditor. That is, the Sarbanes-Oxley Act requires all U.S. publicly traded companies to attest to their internal control environment. Therefore, a company managing a portion of a customers control environment needs to provide assurance to its customers that the internal control environment is in compliance.

Previously, corporate governance leaders and decision makers gained assurance through cyclical audit examinations recurring annually. However, subsequent changes in the control environment tend to expand risk, increase uncertainty and diminish the relevance of a retrospective audit report. Cyclical audits are typically localized, static, time-consuming events that provide limited visibility to emerging risk. In other words, cyclical audits provide a snapshot of the condition of internal controls, taken at the time of the audit. From audit to audit the condition of internal controls is virtually unknown. There is little, if any, forecasting that occurs at an on-site cyclical audit.

Another problem with the audit process is the level of complexity of the audit report. That is, the audit process will evaluate the IT environment at a plurality of levels and produce results at the technical level. Therefore, a manager at the business process level will need to review the audit in full and manually select the applications, systems and infrastructure under his specific management. In so doing, managing a single business process presently requires reviewing an audit at an overly technical level requiring significant investment of the managers time and resources. Therefore, due to the complexity and time-investment requirements, a business process manager may not have the time or technical knowledge to successfully comprehend every error noted in the audit.

For example, since the business process manager is responsible for the infrastructure, the systems and the applications for a given business process, the manager will not have the time to personally evaluate each and every portion of an audit in the same manner as an infrastructure technician would be able to focus on a specific switch or router operation at the infrastructure level. In addition, even if the audit process was performed at an increased interval (e.g., quarterly, monthly and the like), the business process manager would not be able to evaluate each and every subsystem of the business process to ensure proper control and effective risk management due to the time consuming nature and technical level of the components involved in the audit process and the value of the managers time.

### SUMMARY

A method and system for automatically testing information technology control is disclosed. The method includes automatically accessing a plurality of data results pertinent to a plurality of process-based leading indicators and a plurality of symptomatic lagging indicators, wherein the plurality of process-based leading indicators is correlated with the plurality of symptomatic lagging indicators. In addition, the method includes automatically aggregating at least a portion of the plurality of data results into at least one process control indicator for providing an overview picture of the IT control and the emerging risk for at least one process control area.

### BRIEF DESCRIPTION OF THE DRAWINGS

FIG. 1 is a flow diagram for a method of automating an audit process, according to one embodiment.

FIGS. 2A, 2B and 2C are lists illustrating exemplary samples of process-based leading indicators and symptomatic lagging indicators for security, maintenance and availability categories, respectively, related to an Informational Technology application, in accordance with one embodiment.

FIG. 3 is a flow diagram for a method of forecasting the effectiveness and efficiency of controls using process-based indicators, in accordance with one embodiment.

FIG. 4 is a graph illustrating an exemplary report showing the trending and forecasting of a symptomatic lagging indicator, in accordance with one embodiment.

FIG. 5 is a block diagram of a forecasting system for predicting the effectiveness and efficiency of controls using process-based indicators, in accordance with one embodiment.

FIG. 6 is a block diagram of a generic computer system on which embodiments may be performed.

FIG. 7 is a diagram of an exemplary IT control environment in accordance with an embodiment.

FIG. 8 is an aggregation and propagation chart according to an embodiment.

FIG. 9 is a diagram of an exemplary hierarchical relationship contained within a simple configurations management database in accordance with an embodiment.

FIG. 10A is a graph of an exemplary embodiment for the availability management monitored profile holistic approach in accordance with an embodiment.

FIG. 10B is a graph of an exemplary embodiment for the availability management monitored profile additive approach in accordance with an embodiment.

FIG. 11 is a flowchart of the method for automatically testing information technology (IT) control and emerging risk of at least one process control area in a system in accordance with an embodiment.

### DETAILED DESCRIPTION

Reference will now be made in detail to embodiments of the invention, examples of which are illustrated in the accompanying drawings. While the invention will be described in conjunction with the embodiments, it will be understood that they are not intended to limit the invention to these embodiments. Furthermore, in the following detailed description, numerous specific details are set forth in order to provide a thorough understanding of the present invention. In other instances, well known methods, procedures, and components have not been described in detail so as not to unnecessarily obscure aspects of the present invention.

The following detailed description pertains to automatically testing an IT control and emerging risk process control area. For purposes of clarity and brevity, the following discussion will explain the present method and system with respect to an Informational Technology (IT) environment. It should be noted, however, that although such an example is explicitly provided below, the method and system is well suited to use with various other types of environments including, but not limited to, IT environments (e.g., financial audits, operational audits, etc.).

Embodiments include a method and a system for automatically testing information technology (IT) control and emerging risk of at least one process control area in a system. One goal is to reduce the overall set of metrics in a process control area. In one embodiment, the reduction of the overall set of metrics is achieved by combining the metrics into a bigger-picture reduced-detail document available for higher-level system review. Another embodiment provides selecting a reduced number of marker metrics and utilizing them as key indicators of overall process control area health and risk evaluators at the higher level. In so doing, a method of reducing the complexity and amount of time necessary for a managing entity to review a process control area for proper operation and risk evaluation is achieved. Thereby increasing a manager's oversight capability without deleteriously affecting the managers time allocation or providing the oversight at an unnecessarily high level of complexity.

The following detailed description will begin with a description of a method for automating an audit process. The method is outlined the commonly owned U.S. patent application, Attorney Docket No. HP-200403841-1, Ser. No. 10/843,758 filed May 10, 2004, by B. Ames et al., entitled “A Method And System For Automating An Audit Process,” and hereby incorporated by reference in its entirety.

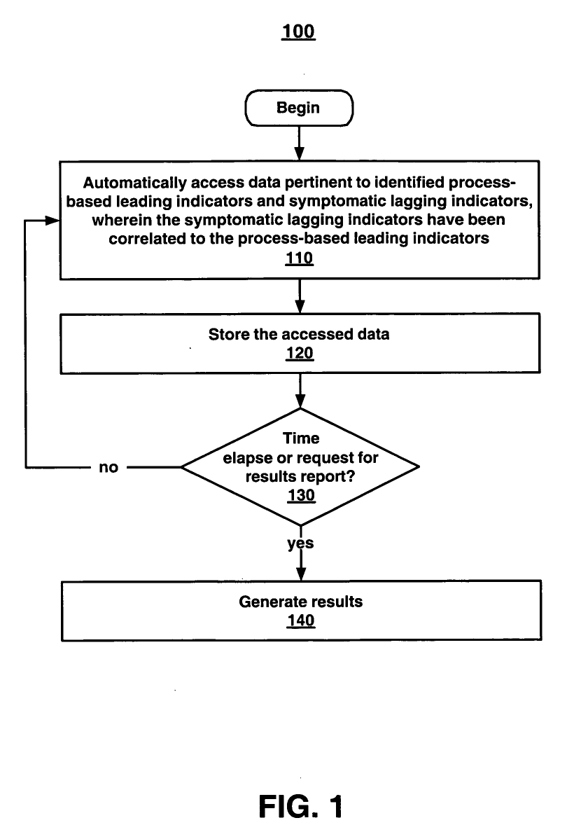

In general, the method for automating an audit process provides an automatic evaluation tool for automating an audit process and forecasting risk for adaptive environments. The automated audit process is a tool set for continuously monitoring emerging risk in an adaptive control environment. The monitoring model measures leading and lagging indicators of IT risk related to critical business processes. The indicators are gathered periodically, systematically and remotely from application systems and host platforms. Results of monitoring are organized in categories that are meaningful to controllership, corporate governance, internal auditors and external auditors. Indicators of risk and management's response to risk are compared and trended over time by aligning the monitoring results of key financial processes (e.g., account reconciliation), business applications (e.g., SAP application) and related technologies (e.g., UNIX). Through ongoing measurement of dispersed, key processes and data, management and auditors are given clear visibility to the control environment, how it is adapting to change and where it is headed. Therefore, the description of FIGS. 1-6 provides one exemplary embodiment for monitoring an IT control environment and providing continuous assessment of the effectiveness.

Automating an Audit

With reference now to FIG. 1, a flow diagram of a method 100 for automating an audit process, according to one embodiment. At step 110 of method 100, data pertinent to identified process-based leading indicators and symptomatic lagging indicators is automatically accessed, wherein the process-based leading indicators are correlated with one or more related symptomatic lagging indicators. For purposes of the present application, the term “process-based leading indicator” is intended to mean an indicator which measures an activity or procedure that is part of internal control. Such control activities are typically designed by management to prevent errors from being introduced into the system. (e.g., granting access restrictions to certain capabilities). Additionally, the term “symptomatic lagging indicator” is intended to mean an indicator which measures the affect of the control activity in the data. This indicator would typically detect occurrences of error that may have been introduced in the system (e.g., a transaction that was improperly authorized).

These process-based leading indicators for risk assessment that are identified for monitoring have been determined empirically from a database of information accumulated over many on-site audits. These process-based indicators may also be derived from widely accepted best practices and known risk areas across the audit profession. As an example, if a process entails the granting, modifying and removing of access or user privileges on a system application, some process-based leading indicators of risk may be the determining if the process is repeatable, if privilege system accounts are restricted to IT users, or if privileges are commensurate with job function.

According to one embodiment, each of the process-based leading indicators is aligned with a relevant category. For example, the process-based leading indicators mentioned above as associated with the IT processes of granting, modifying and removing privileges may be associated with the category of system security. Other IT risk categories may be those of maintenance of a system and availability of a system. The categories may be any categories for which processes afford potential risk and for any discipline in which an audit process is appropriate. The risk categories for any particular discipline are typically identified to be those in which a human being may introduce an error into a system or process.

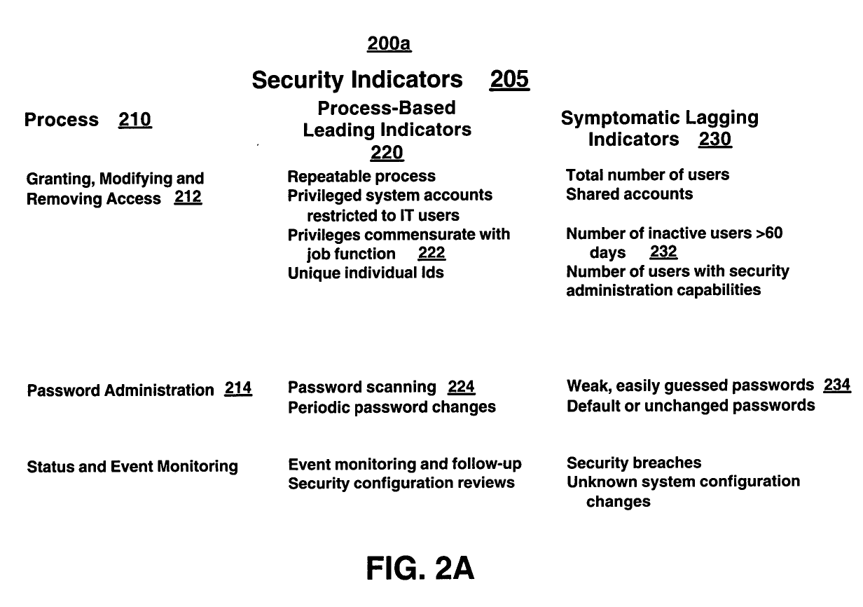

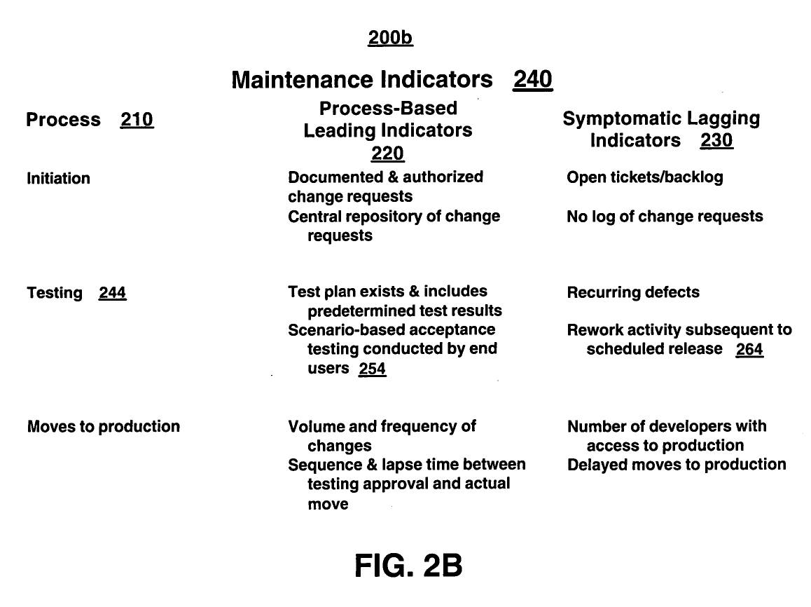

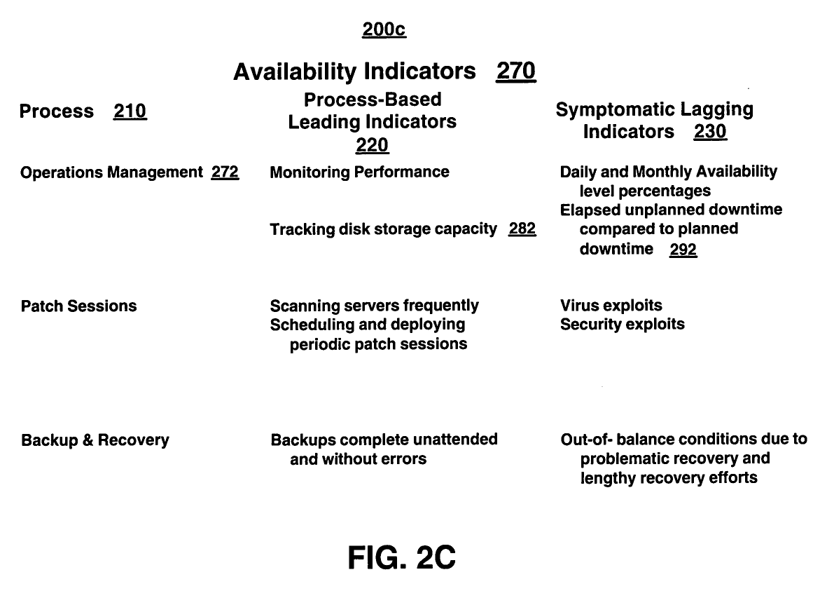

Referring still to step 110 of method 100, once the process-based leading indicators have been identified for the respective relevant categories, in accordance with one embodiment, symptomatic lagging indicators are determined. Often the symptomatic lagging indicators are non-obvious. For example, it has been determined that a lagging indicator for a breach in the security of a system is that of a large number of inactive accounts, a non-obvious relationship. It has been determined that if too much access is granted to holders of accounts, they can perform tasks that are beyond the scope of their job function, and a breach of security can occur. If there is a large number of inactive accounts, it indicates that the accounts are not being monitored and cleared out in a timely manner, which is further indicative of there being insufficient controls in the security process of granting, modifying and removing access. FIGS. 2A, 2B and 2C below show a few exemplary process-based indicators for categories of security, maintenance and availability, respectively.

In one embodiment, after the process-based leading indicators are aligned with a relevant category and correlated with symptomatic lagging indicators, access to data pertinent to the indicators is automated. The pertinent data may be collected from any number of applications or systems (e.g., SAP systems) by a monitoring system.

Still referring to step 110 of FIG. 1, one part of the data (PULL-data) can be delivered by a client module that is installed on every application instance. The areas covered by the data pull may be data such as User data, Role/Profile data and critical transaction data. Another part of the data (PUSH-data) may need to be entered by system-responsible persons and cover Availability and Maintenance information. One purpose of the automated process is to show trends in the single key risk indicators of an application/system as there is a data history available for every application/system. However, reporting tools also allow a comparison of data between different systems.

At step 120 of method 100, the data that has been accessed is stored within the system for retrieval at an appropriate time, according to an embodiment. An appropriate time may be when a predetermined time period has elapsed, when data reaches a predetermined value r when a user-demand is executed.

At step 130 of method 100, a check is performed to determine if it is appropriate to generate results, according to one embodiment. A regular periodic reporting period, (e.g., once per month, once per week or once per quarter) may be predetermined and configured into the application/system. The attaining of one of these preconfigured time periods may trigger the generation of results. According to one embodiment, there may be a comparison of pertinent data with predetermined threshold values and, if the data attains the threshold value or a pre-specified fraction of such a threshold value, there may be an alert message generated. If it is not an appropriate time to generate results, the method continues to access and store the pertinent data until such time as generated results are appropriate.

At step 140 of method 100 of FIG. 1, results are generated. The results may be in the form of a listing of pertinent data, a bar chart, a graph or an alert message, or any appropriate output for reporting the data. The results may be for one or any number of applications and may be cumulative or comparative. That is, the results may include data pertinent to a process-based indicator for a single application instance or the accumulated values for all instances. Also, the data may be compared from instance to instance or between sets of instances. Instances are representative of business processes in worldwide business operational units and geographies.

FIGS. 2A, 2B and 2C illustrate exemplary sets of process-based leading indicators and symptomatic lagging indicators for security, maintenance and availability processes, respectively, related to an Informational Technology (IT) application, in accordance with one embodiment. It should be understood that embodiments are well suited for disciplines other than IT and that appropriate process-based indicators may be generated for processes related to other disciplines (e.g., finance, operations, etc.).

FIG. 2A shows, according to one embodiment, an example of a small sample listing 200a of security indicators 205 with their associated processes 210, process-based leading indicators 220 and symptomatic lagging indicators 230. For the process of granting, modifying and removing access 212, a typical example of a leading indicator may be that of privileges being commensurate with job function 222. As discussed earlier, when too much access is granted, it is easy for a security breach to occur, often inadvertently. If the people setting up security are not sufficiently diligent in establishing and enforcing controls, users can misbehave on a system. Thus, a symptomatic lagging indicator for privileges being commensurate with job function may be the number of inactive users >60 days 232. Although the significance of this lagging indicator may not be immediately obvious, it could be indicative of lack of diligence in security control.

Still referring to FIG. 2A, another example of a security process 210 with associated process-based leading indicators 220 and symptomatic lagging indicators 230 is that of process password administration 214. An example of a leading indicator might be that of scanning the quality of passwords 224, a control process that might prevent the symptomatic lagging indicator of weak, easily guessed passwords 234, which, in turn, may cause a breach of security.

Referring now to FIG. 2B, according to an embodiment, an example of a small sample listing 200b of maintenance indicators 240 with their associated processes 210, process-based leading indicators 220 and symptomatic lagging indicators 230 is illustrated. For the process of testing 244, a typical example of a leading indicator may be that of having scenario-based acceptance testing conducted by end users 245. Without this control in place, a symptomatic lagging indicator may, for example, have to schedule and perform rework activities subsequent to scheduled release 264.

FIG. 2C shows an example of a small sample listing 200c of availability indicators 270 with their associated processes 210, process-based leading indicators 220 and symptomatic lagging indicators 230. For the process of operations management 272, a typical example of a leading indicator may be that of tracking disk storage capacity 282. A symptomatic lagging indicator may be that of having a large percentage of unplanned downtime compared to planned downtime 292. In this case, the relationship stems from the fact that unplanned downtime may well be the result insufficient disk storage space, although this may not be immediately obvious. If the administrators who on track disk storage capacity were sufficiently diligent, it may be expected that the number of unplanned outages may be reduced.

A large volume of leading and lagging indicators may be correlated following accumulation of data over multiple audit cycles. This correlation of frequently non-obvious indicators is important in the automation of an audit process.

Forecasting Risk Using an Automated Audit

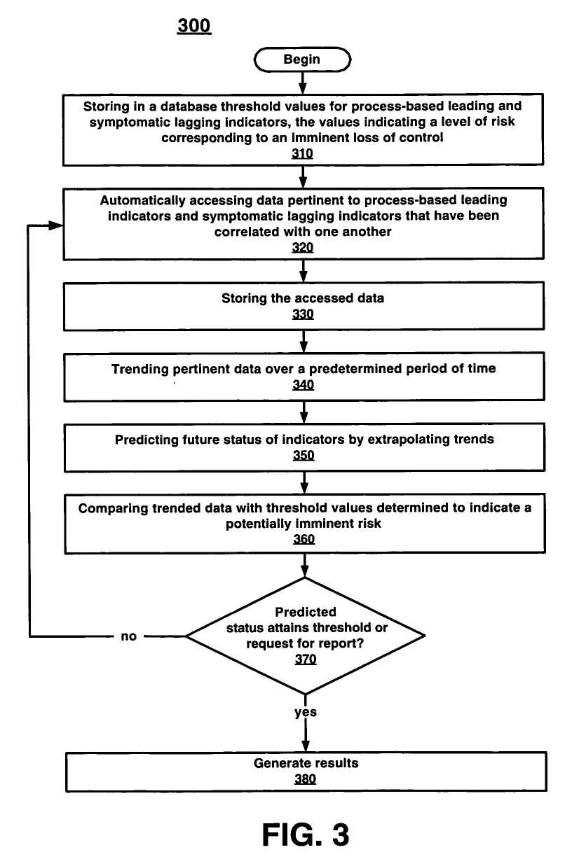

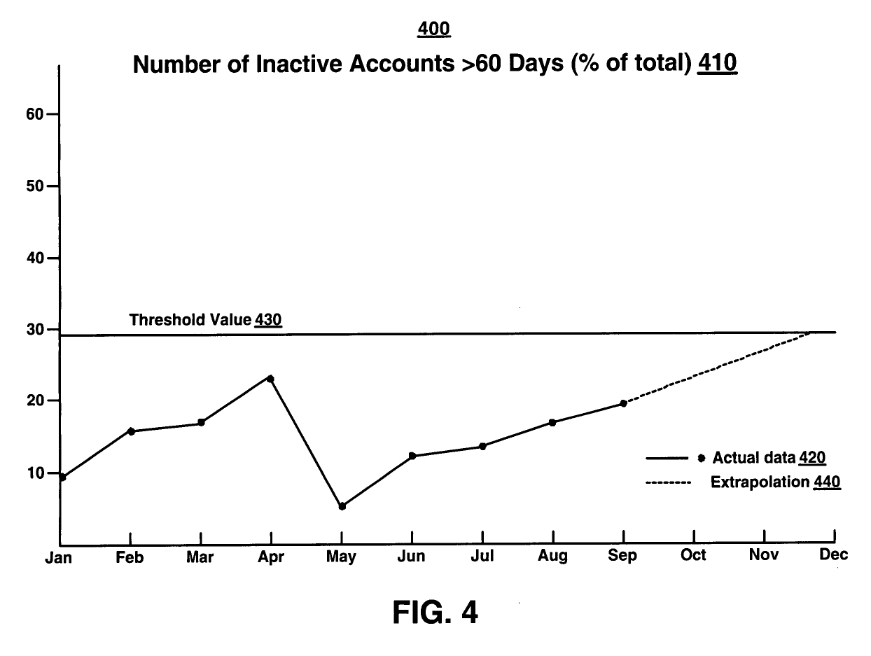

FIG. 3 is a flow diagram for a method 300 of forecasting the effectiveness and efficiency of controls using process-based indicators, in accordance with one embodiment. Portions of method 300 will be discussed in concert with FIG. 4, wherein FIG. 4 is a graph illustrating an exemplary report showing the trending and forecasting of a symptomatic lagging indicator, in accordance with one embodiment.

At step 310 of method 300, according to one embodiment, a threshold value is stored in a database, when pertinent, for each of a set of process-based leading indicators and symptomatic lagging indicators, wherein the threshold value indicates a level of risk corresponding to an imminent loss of control. These threshold values are derived empirically from data collected over numerous instances of on-site audits and analyzed to determine at what level of risk the controls of a particular process become ineffective. These process-based indicators may also be derived from widely accepted best practices and known risk areas across the audit profession. The threshold values may be percentages, fractions or absolute values, depending on the type of data for which they apply. Further, in one embodiment, the threshold value pertains to a process-based leading indicator. In another embodiment, the threshold value pertains to a symptomatic lagging indicator. Also, in yet another embodiment, the threshold value pertains to a combination of the process-based leading indicator and one or more corresponding symptomatic lagging indicators.

At step 320 of method 300, data pertinent to a plurality of process-based leading indicators and a plurality of symptomatic lagging indicators is accessed. The process-based leading indicators have been previously correlated with the plurality of symptomatic lagging indicators. These process-based leading indicators for risk assessment that are identified for monitoring have been determined empirically from a database of information accumulated over many on-site audits. These process-based indicators may also be derived from widely accepted best practices and known risk areas across the audit profession. As an example, if a process entails the granting, modifying and removing of access or user privileges on a system application, some process-based leading indicators of risk may be the determining if the process is repeatable, if privilege system accounts are restricted to IT users, or if privileges are commensurate with job function.

According to one embodiment, each of the process-based leading indicators is aligned with a relevant category. For example, the process-based leading indicators mentioned above as associated with the IT processes of granting, modifying and removing privileges may be associated with the category of system security. Other IT risk categories may be those of maintenance of a system and availability of a system. The categories may be any categories for which processes afford potential risk and for any discipline in which an audit is appropriate. The risk categories for any particular discipline are typically identified to be those in which a human being may introduce an error into a system or process.

Referring still to step 320 of method 300, once the process-based leading indicators have been identified for the respective relevant categories, in accordance with one embodiment, symptomatic lagging indicators are determined. Often the symptomatic lagging indicators are non-obvious. For example, it has been determined that a lagging indicator for a breach in the security of a system is that of a large number of inactive accounts, a non-obvious relationship. It should be noted that there might be several symptomatic lagging indicators corresponding to a single process-based leading indicator.

It has been determined that if too much access is granted to holders of accounts, they can perform tasks that are beyond the scope of their job function, and a breach of security can occur. If there is a large number of inactive accounts, it indicates that the accounts are not being monitored and removed from the application in a timely manner, which is further indicative of there being insufficient controls in the security process of granting, modifying and removing access. FIGS. 2A, 2B and 2C above show a few exemplary process-based indicators for categories of security, maintenance and availability, respectively.

In one embodiment, after the process-based leading indicators are aligned with a relevant category and correlated with symptomatic lagging indicators, access to data pertinent to the indicators is automated. The pertinent data may be collected from any number of applications or systems (e.g., SAP systems) by a monitoring system.

At step 330 of method 300, according to one embodiment, the accessed data is stored by the monitoring system until an appropriate time elapses, a user demand is received or an event occurs to trigger the generation of results.

At step 340 of FIG. 3, according to one embodiment, the data may be trended. For an example, if the data were accumulated on a monthly basis, it could be trended for a quarter, a number of quarters, or for one or more years. The data may be trended for a single instance of an application, or for an accumulation of many applications.

Referring to FIG. 4, a graph illustrating an example of trending and forecasting of a symptomatic lagging indicator is presented, in accordance with one embodiment. In the present example, the percent of the actual data 420 showing a total number of accounts that have been inactive in excess of 60 days 410 is shown to be trended on a monthly basis over a period of two quarters plus two months into a third quarter.

In this example, according to one embodiment, a threshold value 430 is shown to exist when 30 percent of all accounts have been inactive for at least 30 days. This indicates that, should the actual percentage of inactive accounts reach the threshold value 430 of 30 percent, the security controls (e.g., for granting, modifying and removing access as shown in FIG. 2A) would be considered to have broken down, showing that the system administrators may not be diligent in monitoring accounts. When the data are accessed, the values may be compared to the stored threshold values to determine if an alert message may be appropriate.

In the present example of FIG. 4, it can be seen that the trend of actual data 420 that started at approximately 12% inactive accounts in January, rose through February and March to reach a high of approximately 25% inactive accounts in April. In May, it appears that the trend had been noticed and that a correction had been made (e.g., inactive accounts removed from the application) so that the percentage of inactive accounts was back down to around 5%. This would indicate that the controls were in place and that the administrators were being diligent. Then, the trend can be seen to increase again over the next 4 months with no corrections being made.

Referring back to FIG. 3, at step 350, a future status of the data, based on an extrapolation of the trending, is predicted, according to an embodiment. In the example shown in FIG. 4, the extrapolation 440 can be seen as a simple linear extrapolation the would predict that the threshold value 430 of 30 percent inactive accounts could be reached in mid-November. Depending on the type of data being monitored and the periodicity of the monitoring, any mathematical extrapolation that would characterize the trend of the data may be used.

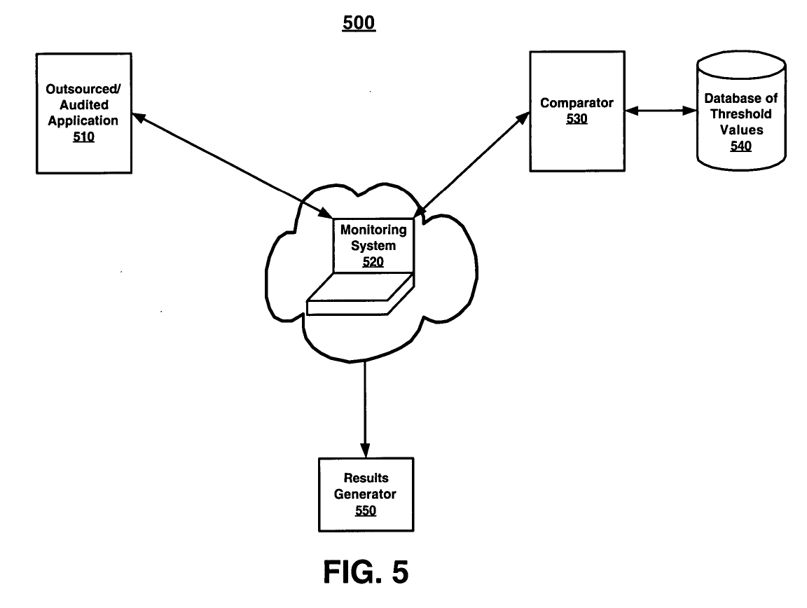

At step 370 of method 300, according to one embodiment, a check is made to see if the predicted future status will reach its threshold value, or if there is a request for a report. According to an embodiment, when the future status of the data indicates the attaining of a threshold value, the monitoring system may request that the results generator issue an alert message to indicate the potential loss of control at the future date. Also, should the data reach its threshold value, as determined by a comparison of the accessed data with its threshold value (e.g., by comparator 530 of FIG. 5), an alert message may be issued. The alert messages may be sent to the appropriate system administrator, as well as to corporate governance and auditors, alerting them of a potential breakdown of controls.

There may also be a request for a report to be generated, either by user demand or be a period of time having elapsed that triggers a report. If there is no request for an alert message to be generated or for results to be reported, method 380 returns to step 320 and continues. If there is a request for an alert message or a report, method 300 proceeds to step 380.

At step 380 of FIG. 3, results are generated. The results may be in the form of a listing of pertinent data, a bar chart, a graph or an alert message, or any appropriate output for reporting the data. The results may be for one or any number of applications and may be cumulative or comparative. That is, the results may include data pertinent to a process-based indicator for a single application instance or the accumulated values for all instances. Also, the data may be compared from instance to instance or between sets of instances.

System for Generating an Automated Audit

FIG. 5 is a block diagram of a forecasting system 500 for predicting the effectiveness and efficiency of controls using process-based risk indicators, in accordance with one embodiment of the present invention. Outsourced/Audited Application 510 of FIG. 5 is an application (e.g., an SAP application) for which controls are being monitored in order to determine their effectiveness and efficiency. These controls are characterized in terms of process-based risk indicators, both leading and (symptomatic) lagging. Examples of such indicators are discussed in detail in conjunction with FIGS. 2A, 2B and 2C above.

A monitoring system 520 of FIG. 5 receives and stores pertinent data from Outsourced/Audited Application 510 that relates to the process-based indicators, according to one embodiment. This data is received from Outsourced/Audited Application 510 on a predetermined periodic basis. The periodicity for receiving the data may be hourly, daily, weekly or monthly, or for any interval that would be determined as effective for a particular set of data being monitored. The data is then stored by monitoring system 520. In one embodiment the monitoring system 520 trends the data over predetermined time intervals. In another embodiment, monitoring system 520 extrapolates the data in order to forecast a future level of risk.

Database 540 of FIG. 5 contains threshold values for the data related to process-based indicators, according to an embodiment of the present invention. These threshold values are systematically determined empirically from sets of data. The threshold values, when attained, indicate a level of risk indicative of an imminent loss of control for which an alert message may be generated. The alert message can be made available to a spectrum of interested parties such as, for example, corporate management, internal auditors, external auditors, etc.

According to one embodiment of the present invention, Comparator 530 compares the data received by Monitoring System 520 to the relevant threshold values from database 540 and forwards the comparison data to monitoring system 520 for deciding if an alert message is appropriate.

Still referring to FIG. 5, Results Generator 550 generates results in the form of reports and alert messages, in accordance with one embodiment of the present invention. The reports may be lists of values of data relating to the process-based indicators, graphs (e.g., the graph shown in FIG. 4), bar charts, or any format appropriate for reporting a particular set of data. The results may be for one or any number of applications and may be cumulative or comparative. That is, the results may include data pertinent to a process-based indicator for a single application instance or the accumulated values for all instances. Also, the data may be compared from instance to instance or between sets of instances. Report Generator 550 may also generate alert messages when the Monitoring System 520 determines from Comparator 530 data that a threshold value has been, or is about to be, attained.

Computer System for Performing Automated Audit

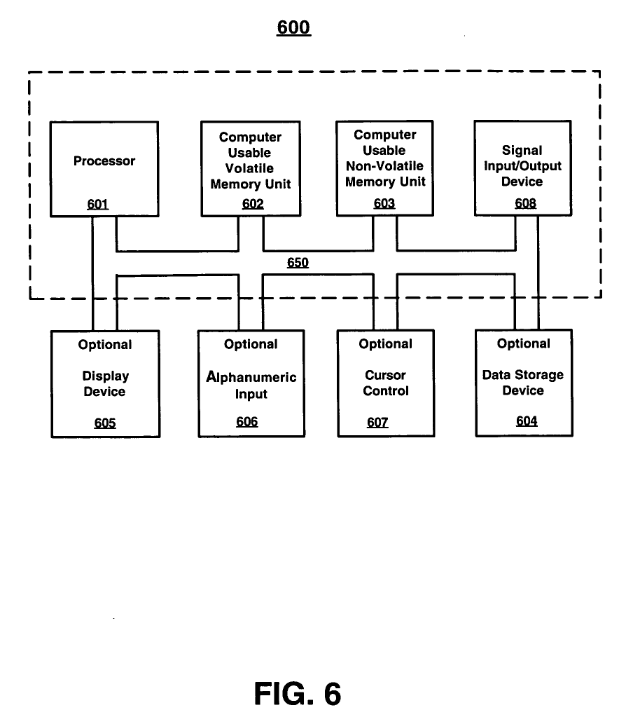

Refer now to FIG. 6. The software components of embodiments run on computers. A configuration typical to a generic computer system is illustrated, in block diagram form, in accordance with one embodiment of the present invention, in FIG. 6. Generic computer 600 is characterized by a processor 601, connected electronically by a bus 650 to a volatile memory 602, a non-volatile memory 603, possibly some form of data storage device 604 and a display device 605. It is noted that display device 605 can be implemented in different forms. While a video cathode ray tube (CRT) or liquid crystal diode (LCD) screen is common, this embodiment can be implemented with other devices or possibly none. System management is able, with this embodiment of the present invention, to determine the actual location of the means of output of alert flags and the location is not limited to the physical device in which this embodiment is resident.

Similarly connected via bus 650 are a possible alphanumeric input device 606, cursor control 607, and signal I/O device 608. Alphanumeric input device 606 may be implemented as any number of possible devices, including video CRT and LCD devices. However, embodiments can operate in systems wherein intrusion detection is located remotely from a system management device, obviating the need for a directly connected display device and for an alphanumeric input device. Similarly, the employment of cursor control 607 is predicated on the use of a graphic display device, 605. Signal input/output (I/O) device 608 can be implemented as a wide range of possible devices, including a serial connection, universal serial bus (USB), an infrared transceiver, a network adapter or a radio frequency (RF) transceiver.

Traditionally, audits provided assurance by examining and inspecting samples of transaction detail in order to assess risk and evaluate the control environment. Fieldwork examination, the most expensive and intrusive part of an audit, may take weeks or months due to the complexity of the organization. Furthermore, changes in the environment tended to lessen the reliability of testing results. Existing automated audit tools provide functionality for performing transactional data analysis and examining system configuration settings, but they do not enable the capability of continuous measurement and reporting on process-based leading indicators and symptomatic lagging indicators across multiple systems and processes simultaneously. Embodiments provide ongoing monitoring of process-based leading indicators and symptomatic lagging indicators, making difficult things easier to see.

By systematically measuring key risk indicators, in accordance with embodiments of the present invention, controllership, corporate governance and auditors are enabled to identify, analyze and disclose changes in the control environment as required by the Sarbanes-Oxley Act of 2002. They are able to measure and respond to risk transparently and deploy resources precisely in order to cap and contain emerging risk. In addition, controllership, corporate governance and auditors are able to ensure that the control environment adapts and continues to operate effectively under accelerated change and strategically predict the effectiveness of the control environment.

When financial processes, business applications, and related IT indicators are aligned accordingly, these monitoring activities can provide assurance as to the reliability of financial reporting information that has not previously existed without performing traditional audit examinations. The continuous monitoring techniques set for the in embodiments may be portable to globally dispersed customers with changing, complex organizations, who can benefit from prospectively measuring their own readiness in connection with Sarbanes-Oxley Act attestation efforts.

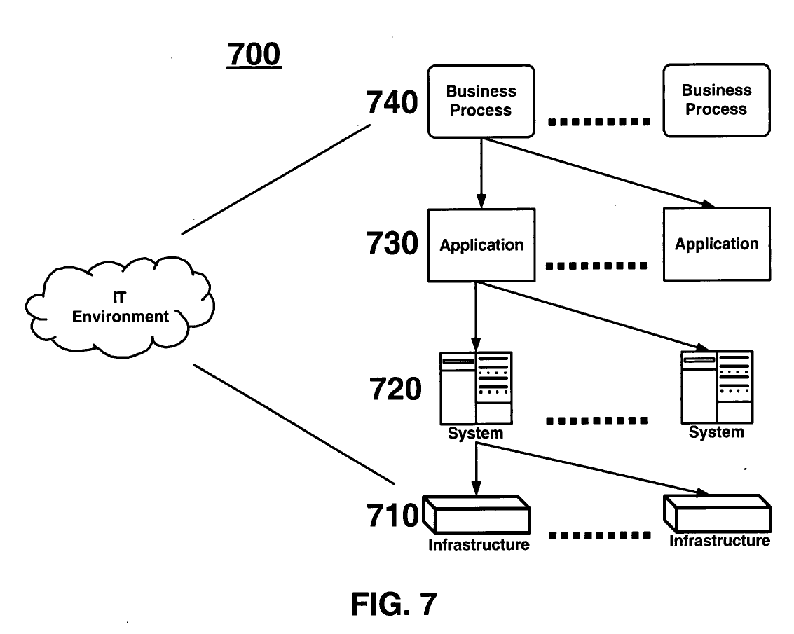

With reference now to FIG. 7, an exemplary IT control environment 700 is shown in accordance with an embodiment of the present invention. In general, IT control environment 700 is one embodiment on which an automatic monitoring process such as the automatic monitoring process described herein is operated. Although one method of monitoring the processes is described herein, embodiments of the invention are capable of utilizing other monitoring type processes which are not described herein merely for purposes of brevity and clarity.

In one embodiment, the IT control environment constitutes a relevant key business process 740, a supporting application 730, a system 720, and the infrastructure 710. Normally, business processes 740 are supported by one or more applications 730 with one or more instances. Applications 730 are supported by systems 720 and the systems are interlinked via the infrastructure 710 (e.g., networks or the like). The control environment 700 includes the hierarchical structure of independent components that support the relevant business process 740.

In general, infrastructure 710 includes switches, routers, wiring, firewalls and the like. System 720 includes components such as servers, databases, personal computers, storage devices, operating systems and other computing hardware. Applications 730 include the software that may be operated on the system 720 devices. Business process 740 include any business processes that are utilized by a company such as, but not limited to, accounts payable, sales, manufacturing, and the like. Although business process 740, supporting application 730, system 720, and the infrastructure 710 are shown as two components, it is appreciated that each may be made up of more or fewer components. In addition, the business process 740, supporting application 730, system 720, and the infrastructure 710 may be in a single location or spread throughout a plurality of locations.

By utilizing the automated data acquisition method described in FIGS. 1-6, any or all of the business process 740 subsystems can be tracked and evaluated based on performance including symptomatic lagging indicators and process-based leading indicators. In addition, as described herein, threshold values for each pertinent subsystem of system 700 can also be tracked to indicate potentially imminent risk, via trending of the data and extrapolation of the trending. In so doing, pluralities of data results are available for any or all of the system 700 components.

In one embodiment, the desired data for tracking is established using key risk indicators (KRI's) and key control indicators (KCI's). KCI is a metric with a threshold, which, when crossed indicates the presence of a deficiency within the control environment. KRI is a metric with a threshold, which, when crossed indicates emerging material risk within the control environment for a deficiency to occur.

The following is a partial list of the monitored profiles and the KCI's and KRI's that are utilized as indicators. It is appreciated that the following list is not a complete list but a partial list of profiles and indicators. In addition, a particular embodiment may select any or all of the KCI's and KRI's for monitoring purposes.

Availability Management that includes the KCI: unplanned downtime in minutes. That is, the minutes of measured unavailability outside planned minutes of downtime. Availability Management also includes a KRI: service planned downtime in minutes. That is, the aggregated minutes from planned windows of downtime.

Information Security Management that includes the KCI: security provision process breach. That is, the number of times a secondary source (provisioned) is changed outside of process bounds. Information Security Management also includes the KRI's: number of users with privileged accounts and exception users with privileged accounts. That is, users with privileged accounts that do not commensurate with job function.

Incident Management that includes the KCI's: percentage of major incidents outside turnaround time, and duration of major incidents. That is, elapsed minutes while a major incident is resolved. Incident Management also includes the KRI's: number of major incidents, percentage of incidents outside of turnaround time, and total number of incidents.

Change Management that includes the KCI: detected changes without changing documentation. Change Management also includes the KRI's: number of changes and number of emergency changes.

Release Management that includes the KCI: release process breach. That is, the number of detected events where controlled files were changed out of process. Release Management also includes the KRI's: number of emergency releases, number of releases (move to production) and percentage of available critical patches applied. That is, for relevant applications and supporting systems.

Configuration Managements that includes the KCI: number of differences between planned vs. actual configuration items. That is, the number of configuration items where the inventory process exposes weakness in keeping an updated configuration management database. Configuration Management also includes the KRI: number of configuration items.

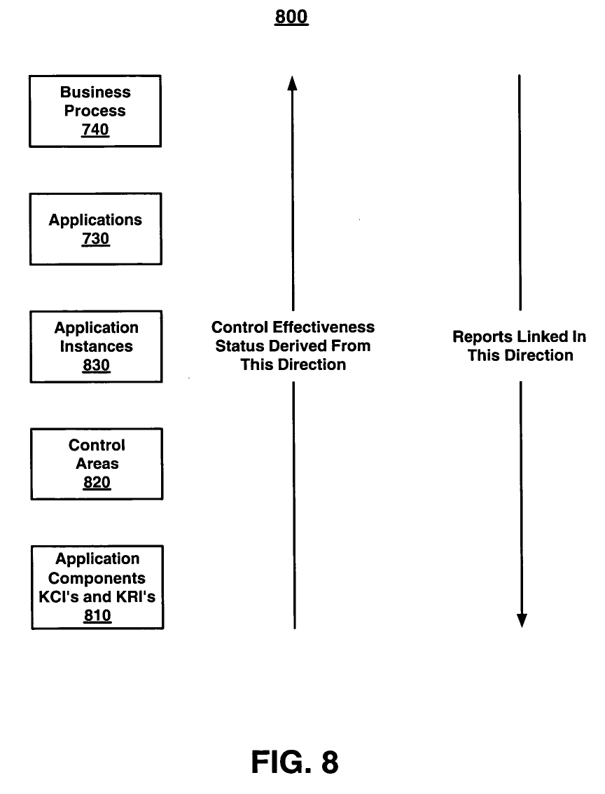

With reference now to FIG. 8, an aggregation and propagation chart 800 is shown according to an embodiment of the present invention. The aggregation and propagation chart 800 is utilized to provide an internal control for the process 740 and its subsystems. The term internal control is a process designed to provide reasonable assurances regarding effectiveness of operations, reliability of financial reporting, compliance with regulations or laws, and the like.

In one embodiment, the aggregation begins at the key control indicators (KCI) and key risk indicators (KRI) 810, then aggregates the KCI and KRI indicators based on control areas 820 to which the KCI and KRI 810 are related. The control areas 820 are then aggregated based on application instances 830 KCI and KRI indicators to which the control areas 820 are related. The application instances 830 KCI and KRI indicators are then aggregated based on applications 730 to which they are related. Finally, the applications 730 KCI and KRI indicators are aggregated based on the business process 740 to which they are related. Although the aggregation and propagation chart 800 include a plurality of aggregated steps, it is understood that there may be more or fewer steps within the aggregation and propagation process. The utilization of five steps in the present embodiment is shown merely for purposes of brevity and clarity.

In one embodiment, the method for automatically testing information technology (IT) control and emerging risk of at least one process control area in a system, uses the KCI and KRI indicators described herein on a periodic and continuous interval to achieve a sustained test of effectiveness. For example, the aggregation and propagation includes pulling data from automated monitoring applications (such as OV Internet services, and OV service Desk, application of Hewlett Packard Inc. of Palo Alto, Calif., or other monitored applications), pulls control gap risk data directly from applications and systems (e.g., privileged users as described herein), aggregates into KCI and KRI for relevant control areas 820, recognizing thresholds and alarms for the KCI's and KRI's based on selected or acceptable operational baselines, and store KCI and KRI indicator metrics for historical reporting.

Historical reporting, as described herein, involves interrelated reports covering steps such as, but not limited to, evaluating thresholds for KCI and KRI based on selected or acceptable operational baselines, aggregating KCI's and KRI's most critical threshold violations to relevant control areas for relevant supporting application components, aggregating most critical threshold violations from control areas for supporting application components to relevant supporting applications, and aggregating most critical threshold violations from supporting applications to relevant business processes.

By utilizing the aggregation and propagation process described herein, at least two important IT control efficiencies are realized. First, instead of a business process manager (or any level manager, the use of the business process manager is merely for purposes of brevity and clarity, there may be similar aggregation and propagation results provided at each step within the chart or to outside sources not directly related to the chart) seeing the results of every KCI and KRI tested, the manager is provided, in one embodiment, with a business process window which will provide the manager with an up-to-date evaluation of the business process operation. That is, the manager will see either a no-worries type message, an actual problem message or possible risk warning message. Therefore, if the aggregated results provide a no problems window, the manager is assured that the components within the business process 740 are operating correctly with no foreseeable problems. However, if the manager receives a warning, then the manager can begin to drill down through the levels of the chart to end up at the problem or risk area.

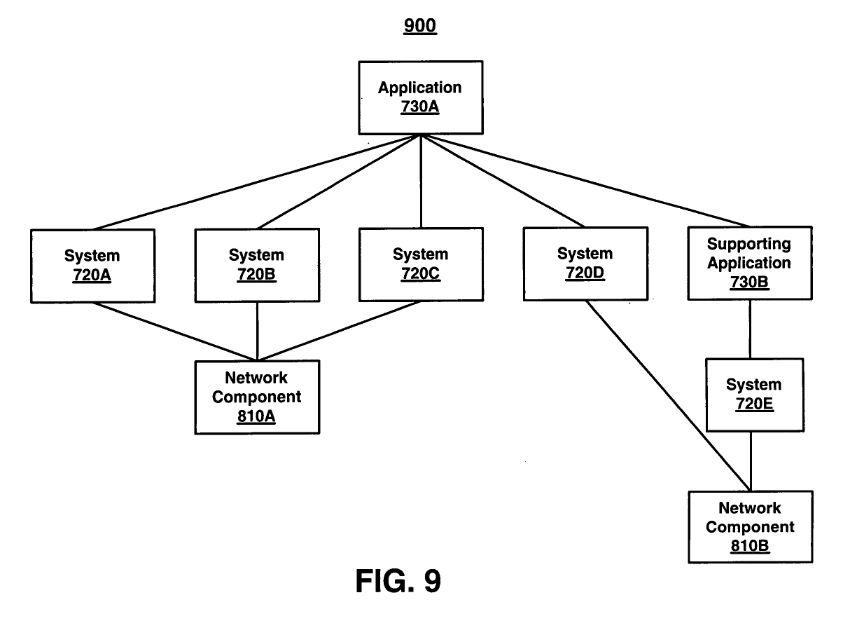

With reference now to FIG. 9, an exemplary hierarchical relationship contained within a simple configurations management database (e.g., a business process database) is shown. The business process may be any process such as, for example, accounts payable. In one embodiment, the business process 740 may have an application 730A and a supporting application 730B, a plurality of systems 720 (e.g., systems 720A-720E), and a plurality of network components (e.g., infrastructure 710A-710B). By traversing the relationships, the supporting components for the accounts payable (or other business process) are realized. In addition, the accounts payable manager can request (or be provided) availability, incident, change, or other statistical data from the corresponding monitoring programs. In one embodiment, the monitored data is based on the established KCI's and KRI's described herein.

For example, a KCI such as unplanned downtime in minutes may be one of the monitored aspects of the network components 820A and 820B. The configuration manager database 900 may receive a warning that an above threshold KCI has occurred. Instead of the manager having to call the technician and have the entire network evaluated, the manager can simply drill down in the configuration management database 900 to realize the application related to the threshold KCI occurrence. In this example, it is application 730A that is receiving the KCI occurrence. At that point, the manager can either contact the person in charge of the application 730A to resolve the problem or the manager can continue drilling down the chart. In either case, the application 720A accessor will drill down to see the system(s) 720 affected. In this case, the affected systems are system 720A through system 720C. At this point, similar to the previous level drill down, the system 720A-C manager (or managers) can be contacted or the searcher can continue to drill down. Again, in either case, the system 720A-720C accessor will drill down to realize that the problem is with network component 810A and not network component 810B.

Once the problem component (e.g., 810A) is found, the standard method for resolving the KCI is initiated. In so doing, the actual detective work in finding the problem and managing the risk are available at a plurality of levels (e.g., component, system, application, or process) without unduly burdening any of the personnel at any of the levels. That is, because the system is automated and simplified, each level of monitoring will be capable of setting preferences and receiving data at a usable level based in KCI's or KRI's instead of receiving a constant and overwhelming amount of data related to various components and various technical aspects thereof.

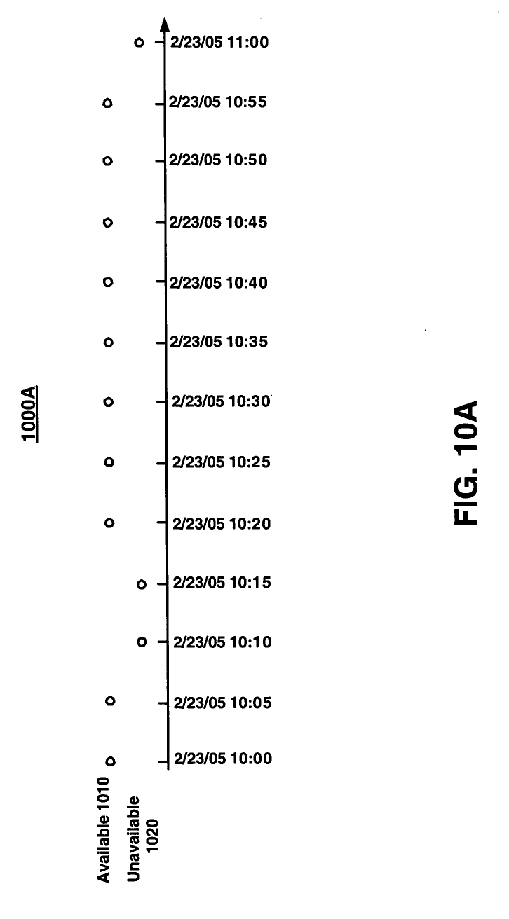

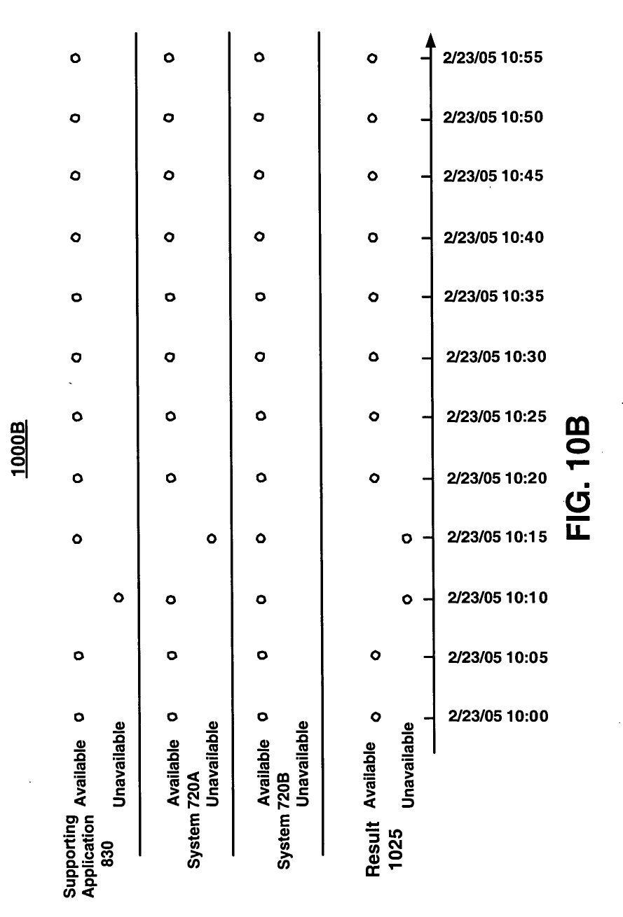

With reference now to FIGS. 10A and 10B, a detailed embodiment of an exemplary availability management monitored profile is provided. Although the availability management profile is described herein, there may be more of fewer KCI's and KRI's utilized in other embodiments. The present number and type of KCI's and KRI's are shown and described merely for purposes of brevity and clarity.

FIG. 10A shows a timeline of compared versus planned downtime for a process 1000. The process 1000 is measured in available time 1010 and unavailable time 1020 in 5-minute intervals. As clearly shown, the process 1000 is available except for up to 15 minutes of unavailability 1020 between the time 10:05 and 10:20.

FIG. 10B graphs the availability of process 1000B to illustrate why the process was not available during the 10:05-10:20 time frame. This is the graph shown after a user drills down from the process 1000A downtime to find the cause of the downtime. Specifically, a subset of the systems and supporting applications and their availability are shown during the same process 1000A time frame. In one embodiment, the list of components is determined from either a static list, or a configuration management database such as FIG. 9. As shown, because the system 720A is unavailable over the 10:15 test time frame and the supporting application 830 is unavailable over the 10:10 test timeframe the process 1000B is also unavailable over the same timeframe. This availability may be scheduled or non-scheduled. In addition, the unavailability may be a worst-case projection (e.g., based on a risk assessment) and not an actual occurrence.

In one embodiment, the graphs 10A and 10B are formed after evaluating the KCI's and KRI's for the availability management profile. In the present example, the KCI's included Unplanned Downtime in minutes. For example, minutes of unavailability outside planned hours of downtime. In this example, the threshold is absolute. That is, the planned hours of downtime are known and any additional downtime is over the threshold. This KCI is for each component and includes end-user application availability and application planned downtime. The KCI further includes drilling down to find the service planned downtime vs. actual downtime and the system availability shown against application availability (e.g., chart 10B).

The KRI's for the Availability management profile include: Application Planned Downtime in minutes. That is, whether the threshold is greater than the last months (or other historical references such as day, week, year, and the like). Moreover, by drilling down, the details of the planned downtime can be realized.

In one embodiment, the calculating of the application availability in minutes is obtained from a plurality of different methods including, but not limited to, the holistic approach and the additive approach. The holistic approach utilizes synthetic transactions every 5 minutes from remote user location, as described herein, to obtain holistic data including application, supporting applications, systems, and network components as shown in FIG. 10A. The additive approach utilizes additive evaluation by aggregating application, supporting applications, systems, and network components availability data to provide the resulting profile downtime 1000B (e.g., as shown in FIG. 10B).

In one embodiment, the calculating of the unplanned downtime in minutes for the application is obtained from a plurality of different methods including, but not limited to, a list of time sequences when routine maintenance or other planned outages will affect availability (e.g. every Friday from 12 pm MST to 2 am MST) or the number of minutes planned for the month (e.g. 480 minutes). In so doing, the KCI threshold will be set at an acceptable percentage outside or passed planned (e.g. 10% or the like). While the KRI threshold will be set at an acceptable percentage difference between current and previous month of application planned downtime (e.g. 8% or the like).

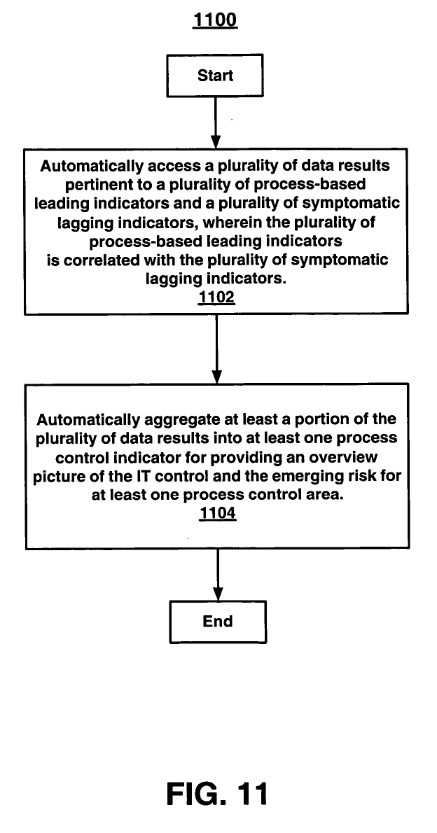

With reference now to FIG. 11, a flowchart 1100 of the method for automatically testing information technology (IT) control and emerging risk of at least one process control area in a system is shown in accordance with an embodiment of the present invention.

With reference now to step 1102 of FIG. 11 and to FIGS. 1-6, one embodiment automatically accesses a plurality of data results pertinent to a plurality of process-based leading indicators and a plurality of symptomatic lagging indicators, wherein the plurality of process-based leading indicators is correlated with the plurality of symptomatic lagging indicators. Examples of this operation are defined in the description of FIGS. 1-6.

Referring now to step 1104 of FIG. 11 and to FIG. 9, one embodiment automatically aggregates at least a portion of the plurality of data results into at least one process control indicator for providing an overview picture of the IT control and the emerging risk for at least one process control area. For example, as described herein, the plurality of data results include establishing KCI and KRI metrics.

Moreover, as shown in chart 900, the aggregation of the data will continue at each level such that each level the results will include a reduced set of metrics based on the desired KCI and KRI metrics being monitored at the particular level or the levels below. In addition, the data is automated during collection to further reduce manual workload.

In one embodiment, the plurality of data results are continuously updated and the aggregation of the data is also continuous thereby providing a continuously updated picture of the IT control and the emerging risk for at least one process control area. In another embodiment, the continuous updating is performed for a plurality or all of the process control areas. In yet another embodiment, the continuous updating is a user preference that can be manually selected for each of the process control areas.

Additionally, the presentation at each level is also optionally modifiable. For example, it can be provided in simple format such as a status window showing the process and its components in good standing, in a risk scenario, or actually in an out of operating standards mode. Moreover, in another embodiment, the presentation is provided in a more detailed format including time of last data update, time till next update, actual KCI and/or KRI numbers and their relation to the threshold values, and the like.

Thus, various embodiments provide, a method and system for automatically testing information technology (IT) control and emerging risk of at least one process control area in a system. Furthermore, embodiments regularly attest to the effectiveness of their control environments that are required by legislative acts such as those described herein. Embodiments additionally aggregate monitored control data into compliance/governance information allowing timely corrective actions against the control environment. Furthermore, predictive readiness is granted for audits thereby providing the result before the assessment. In addition, embodiments provide carry forward audits to reasonably assure that nothing has changed to force a reassessment of the environment. Therefore, a sustained and cost efficient test of effectiveness is attained for internal controls.

The foregoing descriptions of specific embodiments have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.
What is claimed is:

1. A method for automatically testing information technology control, said method comprising:
automatically accessing a plurality of data results pertinent to a plurality of process-based leading indicators and a plurality of symptomatic lagging indicators, wherein said plurality of process-based leading indicators is correlated with said plurality of symptomatic lagging indicators; and
automatically aggregating at least a portion of said plurality of data results into at least one process control indicator for providing an overview picture of said IT control and said emerging risk for at least one process control area.

2. The method as recited in claim 1 further comprising:
storing in a database, where relevant, a threshold value for said data pertinent to each of said plurality of process-based leading indicators and said plurality of symptomatic lagging indicators, said threshold value indicating a level for potentially imminent risk;
trending said data;
predicting a future status of said data based on an extrapolation of said trending; and
generating an alert message when said data attains a predetermined value relative to said threshold value.

3. The method as recited in claim 1 wherein said process control area includes control areas selected from the group consisting of: availability management, information security management, incidental management, change management, configuration management and release management.

4. The method as recited in claim 1 further comprising:
continuously updating said aggregating of said at least a portion of said plurality of data results into said at least one process control indicator for providing a continuously updated overview picture of said IT control and said emerging risk for said at least one process control area.

5. The method as recited in claim 1 further comprising:
establishing a key control indicator (KCI) as a threshold metric, said KCI threshold crossed when a deficiency within said at least one process control area is present.

6. The method as recited in claim 5 further comprising:
storing said KCI for said at least one process control area for historical reporting.

7. The method as recited in claim 1 further comprising:
establishing a key risk indicator (KRI) as a threshold metric, said KRI threshold crossed when an emerging material risk to said at least one process control area is realized.

8. The method as recited in claim 7 further comprising:
storing said KRI for said at least one process control area for historical reporting.

9. An automatic process control area tracker for tracking information technology (IT) control and emerging risk comprising:
a database accessor for automatically accessing a database comprising a plurality of data results pertinent to a plurality of process-based leading indicators and a plurality of symptomatic lagging indicators, wherein said plurality of process-based leading indicators is correlated with said plurality of symptomatic lagging indicators; and
an aggregator for automatically aggregating at least a portion of said plurality of data results into at least one process control indicator for providing an overview picture of said IT control and said emerging risk for at least one process control area.

10. The automatic process control area tracker of claim 9 further comprising:
storing in a database, where relevant, a threshold value for said data pertinent to each of said plurality of process-based leading indicators and said plurality of symptomatic lagging indicators, said threshold value indicating a level for potentially imminent risk;
trending said data;
predicting a future status of said data based on an extrapolation of said trending; and
generating an alert message when said data attains a predetermined value relative to said threshold value.

11. The automatic process control area tracker of claim 9 wherein said process control area includes control areas selected from the group consisting of: availability management, information security management, incidental management, change management, configuration management and release management.

12. The automatic process control area tracker of claim 9 further comprising:
continuously updating said aggregating of said at least a portion of said plurality of data results into said at least one process control indicator for providing a continuously updated overview picture of said IT control and said emerging risk for said at least one process control area.

13. The automatic process control area tracker of claim 9 further comprising:
establishing a key control indicator (KCI) as a threshold metric, said KCI threshold crossed when a deficiency within said at least one process control area is present.

14. The automatic process control area tracker of claim 13 further comprising:
storing said KCI for said at least one process control area for historical reporting.

15. The automatic process control area tracker of claim 9 further comprising:
establishing a key risk indicator (KRI) as a threshold metric, said KRI threshold crossed when an emerging material risk to said at least one process control area is realized.

16. The automatic process control area tracker of claim 15 further comprising:
storing said KRI for said at least one process control area for historical reporting.

17. A computer-usable medium having computer-readable code embodied therein for causing a computer system to perform a method for automatically testing information technology (IT) control and emerging risk of at least one process control area in a system, comprising:
automatically accessing a plurality of data results pertinent to a plurality of process-based leading indicators and a plurality of symptomatic lagging indicators, wherein said plurality of process-based leading indicators is correlated with said plurality of symptomatic lagging indicators; and
automatically aggregating at least a portion of said plurality of data results into at least one process control indicator for providing an overview picture of said IT control and said emerging risk for at least one process control area.

18. The computer-usable medium of claim 17 further comprising:
storing in a database, where relevant, a threshold value for said data pertinent to each of said plurality of process-based leading indicators and said plurality of symptomatic lagging indicators, said threshold value indicating a level for potentially imminent risk;
trending said data;
predicting a future status of said data based on an extrapolation of said trending; and
generating an alert message when said data attains a predetermined value relative to said threshold value.

19. The computer-usable medium of claim 17 wherein said process control area includes control areas selected from the group consisting of: availability management, information security management, incidental management, change management, configuration management and release management.

20. The computer-usable medium of claim 17 further comprising:
continuously updating said aggregating of said at least a portion of said plurality of data results into said at least one process control indicator for providing a continuously updated overview picture of said IT control and said emerging risk for said at least one process control area.

21. The computer-usable medium of claim 17 further comprising:
establishing a key control indicator (KCI) as a threshold metric, said KCI threshold crossed when a deficiency within said at least one process control area is present.

22. The computer-usable medium of claim 21 further comprising:
storing said KCI for said at least one process control area for historical reporting.

23. The computer-usable medium of claim 17 further comprising:
establishing a key risk indicator (KRI) as a threshold metric, said KRI threshold crossed when an emerging material risk to said at least one process control area is realized.

24. The computer-usable medium of claim 23 further comprising:
storing said KRI for said at least one process control area for historical reporting.

25. A method for automatically testing information technology control, said method comprising:
selecting means for automatically selecting a plurality of data results pertinent to a plurality of process-based leading indicators and a plurality of symptomatic lagging indicators, wherein said plurality of process-based leading indicators is correlated with said plurality of symptomatic lagging indicators; and
a combining means for automatically combining at least a portion of said plurality of data results into at least one process control area having a means for providing an overview picture of said IT control for at least one process control area.
